(19) United States
(12) Patent Application Publication
(10) Pub. No.: US 2023/0035264 A1
(43) Pub. Date: Feb. 2, 2023

(54) RAZOR HEADS, KITS, RAZORS & METHODS COMPRISING THE SAME

(71) Applicant: Bic Violex Single Member S.A., Anoixi (GR)

(72) Inventor: Panagiotis POLYGERINOS, Anoixi (GR)

(73) Assignee: Bic Violex Single Member S.A., Anoixi (GR)

(21) Appl. No.: 17/814,268

(22) Filed: Jul. 22, 2022

(30) Foreign Application Priority Data
Jul. 27, 2021 (EP) 21187953.1

(51) Int. Cl. B26B 21/40; B26B 19/38; B26B 21/58

(52) U.S. Cl. CPC B26B 21/4031; B26B 19/3853; B26B 19/3846; B26B 21/58

(57) ABSTRACT

A razor head comprises a frame. The frame comprises a leading longitudinal member and a trailing longitudinal member. The razor head further comprises a plurality of substantially parallel cutting members disposed between the leading longitudinal member and the trailing longitudinal member, and a cutting member support arranged in the frame, wherein the cutting member support is coupled to the plurality of cutting members. The cutting member support is configured to displace at least one cutting member of the plurality of cutting members from a default position to at least one predetermined deviating position based on an external stimulus.

### CROSS REFERENCE TO RELATED APPLICATION(S)

This application claims priority from European Patent Application EP 21187953.1, filed on 27 Jul. 2021, the entire contents of which being incorporated herein by reference.

### TECHNICAL FIELD

The present disclosure relates to the field of razors, more specifically to a razor head, a kit of parts comprising a plurality of razor heads, a razor comprising a razor head, and a method of operating a razor.

### BACKGROUND

Razors (also known as safety razors) have a razor head that is permanently or removably attached to a razor handle which, in use, is oriented in a shaving direction. Razor heads typically comprise one or more cutting members, each comprising a blade that is perpendicular to the shaving direction. Razor heads are also typically provided with a guard (at a leading longitudinal side of the razor head in the shaving direction) and a cap (at a trailing longitudinal side of the razor head in the shaving direction). In use, a user holds the razor handle in the shaving direction and brings the razor head into contact with a portion of skin defining a shaving plane.

In the field of razors, there are various razor models available on the market wherein the razor handles and/or razor heads differ in shape, features, aesthetics, color and/or material. When a user cuts hair in a shaving operation, the razor head can become clogged and may require rinsing, usually with water. Over the years, several techniques have been proposed to minimize clogging of the razor head. However, design solutions that reduce clogging may compromise shaving performance since the spacing between individual cutting members may be increased—which can cause skin irritations and cuts during a shaving operation. In order to find a trade-off between the reduction of clogging and maintaining high shaving performance and safety, there have been various proposals for mounting a razor head on a razor handle to enable movement of the razor head during shaving with the aim of maintaining conformity of the skin contacting parts with the skin surface during shaving and to absorb occurring forces. For example, many razors that are currently on the market have razor heads which are pivotable about an axis extending parallel to the cutting edges of the elongate blades incorporated in the razor heads. In other designs, there are described safety razors with razor head support structures which permit further freedom of movement of the rigid individual cutting members relative to the razor heads and/or razor handles. It has also been proposed to make the individual cutting members flexible between supporting points at its ends so that the razor head can bow under shaving forces. However, it would be desirable to provide razor heads with cutting members that have a high shaving performance, provide high safety and that provide an improved rinsability when clogged. Furthermore, it would be desirable to provide a razor head with cutting members that could be displaced on-demand with other stimuli than forces in order to reduce clogging.

Thus, an object of the present disclosure is to provide a razor head which can lead to improved rinsability, while maintaining or improving safety and shaving performance.

### SUMMARY

The present disclosure relates to a razor head as defined in claim 1, a kit of parts as defined in claim 13, a razor as defined in claim 14, and a method of operating a razor as defined in claim 15. The dependent claims depict advantageous embodiments of the present disclosure.

According to a first aspect of the present disclosure, a razor head comprises a frame. The frame comprises a leading longitudinal member and a trailing longitudinal member. Furthermore, the razor head comprises a plurality of substantially parallel cutting members disposed between the leading longitudinal member and the trailing longitudinal member, and a cutting member support arranged in the frame, wherein the cutting member support is coupled to the plurality of cutting members. The cutting member support is configured to displace at least one cutting member of the plurality of cutting members from a default position to at least one predetermined deviating position based on an external stimulus. This can lead to increased space between the respective cutting members and/or between the cutting members and the frame, more specifically the leading longitudinal member and the trailing longitudinal member. An easier rinsing of cut hair between frame and cutting members and/or between the respective cutting members can be achieved. Furthermore, clogging can be reduced without decreasing shaving performance since an inter-blade span of the respective cutting members (more specifically between the cutting edges) can be kept narrow when shaving and can be increased when rinsing.

In an embodiment, the cutting member support may comprise at least one responsive shape-shift component, which can be configured to perform a shape-shift from the default position to the at least one predetermined deviating position based on the external stimulus. In embodiments, the at least one responsive shape-shift component may comprise a responsive shape-shifting polymer. In embodiments, the responsive shape-shifting polymer may be combined with responsive liquid crystal elastomers (LCE) that are adapted to change their shape back and forth according to the external stimulus applied.

The at least one responsive shape-shift component can be coupled to the at least one cutting member of the plurality of cutting members that is displaceable from the default position to the at least one predetermined deviating position. More specifically, the at least one responsive shape-shift component can be coupled to a side of the at least one cutting member facing towards a center of the frame.

The default position may be provided such that shaving performance by the plurality of cutting members can be increased. The at least one predetermined deviating position may be provided, such that rinsing between the plurality of cutting members, and/or between the plurality of cutting members and the leading longitudinal member, and/or between the plurality of cutting members and the trailing longitudinal member, can be improved.

The razor head may comprise a shaving direction, a perpendicular direction which may be perpendicular to the shaving direction, and a vertical direction which may be perpendicular to the shaving direction and the perpendicular direction.

The frame may comprise a skin-contacting side defining a shaving plane, and wherein the frame may comprise a back side opposite the skin-contacting side.

In embodiments, each cutting member of the plurality of cutting members may comprise a blade having a cutting edge. In the default position, the plurality of cutting members, more specifically the cutting edges of the plurality of cutting members, may be arranged in, or proximate, the shaving plane.

Starting from the default position, the cutting member support may be configured to displace the at least one cutting member of the plurality of cutting members in the shaving direction and/or in the vertical direction and/or by a rotation about an axis defined by the perpendicular direction, based on the external stimulus. Since the cutting members can be displaced either in the shaving direction and/or in the vertical direction and or by a rotation, space between the cutting members and/or the trailing longitudinal member and/or leading longitudinal member can be increased such that rinsing may be improved and/or simplified.

Starting from the default position, the cutting member support may be configured to displace the at least one cutting member of the plurality of cutting members in the shaving direction towards the leading longitudinal member or towards the trailing longitudinal member by an axial distance. In embodiments, the axial distance may be between 0 μm and 1500 μm, more specifically between 0 μm and 1100 μm, measured from the cutting edge of the at least one cutting member in the shaving direction.

Starting from the default position, the cutting member support may be configured to displace the at least one cutting member of the plurality of cutting members in the vertical direction towards the back side of the frame by a vertical distance. In embodiments, the vertical distance may be between 0 μm and 1500 μm, more specifically between 0 μm and 1100 μm, measured from the cutting edge of the at least one cutting member in the vertical direction.

Starting from the default position, the cutting member support may be configured to displace the at least one cutting member of the plurality of cutting members by a rotation about an axis defined by the perpendicular direction, wherein the rotation may be defined by a rotation angle. In embodiments, the rotation angle may be between −20°<r<+20°, more specifically wherein the rotation angle may be between −5°<r<+5°.

In embodiments, in the default position, the plurality of cutting members may define a plurality of substantially parallel first inter-blade spans, wherein the inter-blade spans can be measured parallel to the shaving direction between the subsequent, respective cutting edges of the plurality of cutting members.

In the default position, a second span measured parallel to the shaving direction may be defined between leading longitudinal member and a cutting edge of a cutting member, being disposed adjacent the leading longitudinal member. In the default position, a third span measured parallel to the shaving direction may be defined between trailing longitudinal member and a cutting edge of a cutting member, being disposed adjacent the trailing longitudinal member.

In the predetermined deviating position, at least one of the first inter-blade spans, second span and third span may be larger or smaller than in the default position, depending on the axial distance, vertical distance and/or rotation angle.

In embodiments, the external stimulus may be a temperature variation and/or a moisture variation. In a first temperature range of about 18° C. to 25° C., the plurality of cutting members may be in the default position. Additionally or alternatively, in a second temperature range of about 25° C. to 50° C., the at least one cutting member of the plurality of cutting members may be displaced from the default position to the at least one predetermined deviating position.

The at least one responsive shape-shift component of the cutting member support may be configured to perform a first shape-shift from the default position to a first predetermined deviating position at a first transition temperature, more specifically wherein the first transition temperature may be between 24° C. and 28° C.

The at least one responsive shape-shift component of the cutting member support may be configured to perform a second shape-shift from the first predetermined deviating position to a second predetermined deviating position at a second transition temperature, more specifically wherein the second transition temperature may be higher than the first transition temperature, in particular wherein the second transition temperature may be between 37° C. and 42° C.

In embodiments, the frame may comprise a first side portion and a second side portion, each extending in the shaving direction between leading longitudinal member and trailing longitudinal member on opposite sides of the leading longitudinal member and the trailing longitudinal member, with respect to the perpendicular direction.

The frame may comprise a first cutting member retainer and a second cutting member retainer configured to be pushed onto the first side portion and the second side portion in the perpendicular direction. The first cutting member retainer and the second cutting member retainer may be configured to retain the plurality of cutting members when inserted in the frame.

In embodiments, the cutting member support may comprise a plurality of resilient fingers. A pair of fingers of the plurality of fingers may be coupled to a cutting member of the plurality of cutting members, respectively. Each pair of fingers may be in corresponding alignment in the perpendicular direction.

In embodiments, at least one pair of fingers of the plurality of fingers may comprise the responsive shape-shift component of the cutting member support configured to perform the shape-shift based on the external stimulus.

The cutting member support, more specifically each pair of fingers may be coupled to the plurality of cutting members by positive locking, non-positive locking, or adhesive bonding. Each pair of fingers may extend substantially in the perpendicular direction from the first side portion and the second side portion towards a center of the frame, respectively.

In embodiments, the cutting member support may comprise a base portion that is attached to the frame proximate a center of the frame.

In embodiments, the plurality of fingers may extend from the base portion in the perpendicular direction towards the first side portion and the second side portion, respectively.

In the default position, each finger of the plurality of fingers may be configured to exert a bias force against the plurality of cutting members in the vertical direction towards the shaving plane.

In the default position, the plurality of cutting members may bear against corresponding stop portions, more specifically wherein the stop portions can be the first cutting member retainer and the second cutting member retainer.

In embodiments, the frame, more specifically the first side portion and the second side portion, may comprise a plurality of cutting member guides defining a plurality of cutting member support slots, each cutting member support slot configured to accommodate a cutting member of the plurality of cutting members, wherein each cutting member may be disposed in a respective cutting member support slot.

In an embodiment, the razor head may further comprise at least two spring elements arranged adjacent the first side portion and the second side portion, respectively, between the plurality of cutting members and the frame, more specifically between the plurality of cutting members and first cutting member retainer and the second cutting member retainer, respectively. The at least two spring elements may be configured to exert a bias force in the vertical direction towards a center of the frame.

In the default position, the bias force of the at least two spring elements may be lower than the bias force of the plurality of resilient fingers.

When the at least one responsive shape-shift component performs a shape-shift from the default position to the at least one predetermined deviating position based on the external stimulus, the at least two spring elements may push the at least one cutting member of the plurality of cutting members towards the plurality of fingers in the vertical direction.

On a back side of the frame opposite the skin-contacting side, the frame may comprise a coupling section configured to couple the razor head to a razor handle, more specifically wherein the coupling section may be configured to releasably couple the razor head to the razor handle via a pivotable or a non-pivotable coupling.

According to a second aspect of the present disclosure, a kit of parts is provided which comprises a razor head holder comprising a plurality of razor heads according to any one of the embodiments as described above. The kit of parts further comprises a razor handle.

According to a third aspect of the present disclosure, a razor comprises a razor head according to any one of the embodiments as described above, and a razor handle, wherein the razor head is coupled to the razor handle.

In embodiments, the razor head may be coupled to the razor handle via a coupling section, more specifically wherein the coupling section may comprise a connecting adapter.

In embodiments, the razor head, more specifically the connecting adapter, may be integrally formed with the razor handle, or, the razor head, more specifically the connecting adapter, may be releasably coupled to the razor handle.

In an embodiment, the razor handle may comprise a retention and/or release mechanism configured to couple the razor head to the razor handle and/or to decouple the razor head from the razor handle.

According to a fourth aspect of the present disclosure, a method of operating a razor is provided which comprises the steps of providing a razor comprising a razor head according to any one of the embodiments as described above and performing a shaving operation with the razor, wherein the razor head is configured to cut hair of a user. The methods further comprises the step of exposing the razor head to an external stimulus, wherein the cutting member support is configured to displace at least one cutting member of the plurality of cutting members from a default position to at least one predetermined deviating position based on the external stimulus. The method further comprises terminating the exposure of the razor head to an external stimulus, wherein the cutting member support is configured to replace the at least one cutting member of the plurality of cutting members from the at least one predetermined deviating position to the default position. Due to the displacement of at least one cutting member of the plurality of cutting members, a spacing (span and/or distance to the shaving plane) between the respective cutting members can be temporarily increased such that a rinsing/unclogging of the razor head can be simplified. This can be done without compromising the shaving performance that originates from having the cutting members at a close distance to each other.

In an embodiment, the external stimulus may be a temperature variation and/or a moisture variation. The shaving operation may be performed at a first temperature range.

Exposing the razor head to an external stimulus may comprise rinsing the razor head with a liquid at a second temperature range, more specifically wherein the second temperature range may be higher than the first temperature range.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting embodiments. Common reference numerals on different figures indicate like or similar features.

FIG. 1 is a schematic view of a razor according to the present disclosure;

FIGS. 2A and 2B are a side view and a front view of a razor head according to the present disclosure;

FIG. 3 is an exploded view of the razor head;

FIGS. 4A and 4B are cut-away views of different sections of the razor head parallel to the x-z plane;

FIGS. 5A to 5C are cut-away views of the razor head showing default position and different predetermined deviating positions of respective cutting members;

FIGS. 6A and 6B are schematic views of the razor head showing a first embodiment of the cutting member support;

FIGS. 7A and 7B are schematic views of the razor head showing a second embodiment of the cutting member support;

FIG. 8 is a flow diagram of the method of operating a razor according to the present disclosure;

FIG. 9 is a side view/cut-away view of a cutting member.

### DETAILED DESCRIPTION

Embodiments of the razor head, the kit of parts, the razor and the method of operating a razor according to the present disclosure will be described in reference to the drawings as follows.

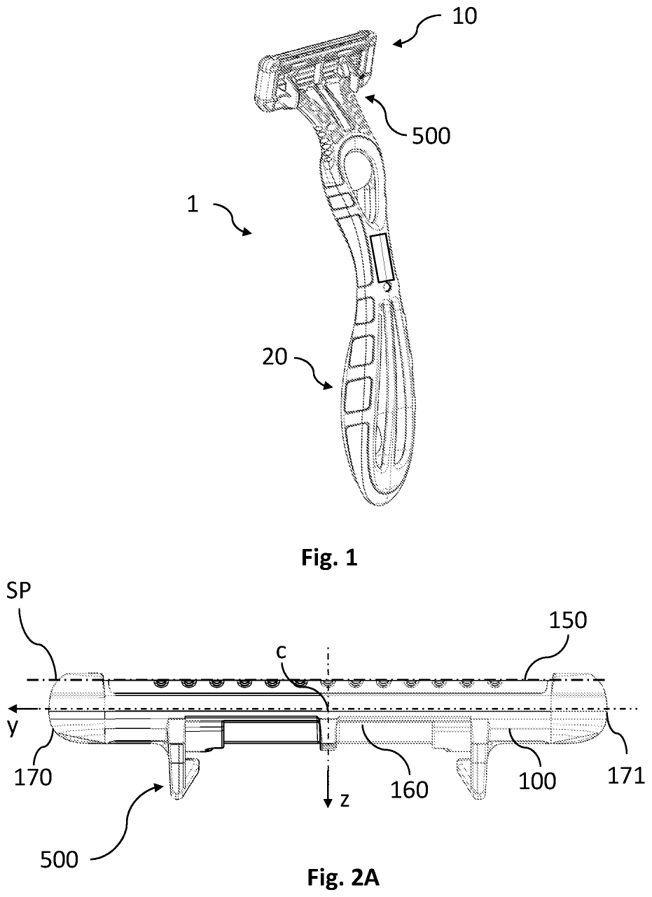

FIG. 1 is a schematic view of a razor 1 according to an aspect of the present disclosure. The razor 1 comprises a razor head 10 and a razor handle 20, wherein the razor head 10 is coupled to the razor handle 20. The razor handle 20 comprises a first end and a second end. The razor handle 20 is coupled to the razor head 10 via a coupling section 500 comprising a connecting adapter. As shown in FIGS. 1, the connecting adapter can be integrally formed with the razor handle 20. Alternatively, the connecting adapter can be releasably coupled to the razor handle 20 (not shown in the Figs.). In an embodiment, the coupling section 500 may be configured to releasably couple the razor head 10 to the razor handle 20 via a pivotable or a non-pivotable coupling. The razor handle 20 may further comprise a retention and/or release mechanism configured to couple the razor head 10 to the razor handle 20 and/or to decouple the razor head 10 from the razor handle 20 (not shown in the Figs.).

In use (wherein the razor head 10 is coupled to the razor handle 20), a user holds the razor handle 20 in a shaving direction x and brings the razor head 10 into contact with a portion of skin. In embodiments, a shaving plane SP is defined as the tangential line intersecting the first and second skin contact points of, for example, a plurality of cutting members 200 of the razor head 10. In other embodiments, the shaving plane SP may be approximated as a tangential line between the highest points on a skin-contacting surface of the razor head 10—for example, the flat plane between the top of a guard and the top of a cap of the razor head 10. During a shaving operation, movement of the razor handle 20 causes the plurality of cutting members 200 of the razor head 10 to be moved across the shaving plane SP in the shaving direction x, enabling the cutting members 200 to remove unwanted hair.

In the following specification and claims, the term “cutting member” means a component of a razor head 10 that, in use, contacts the skin of a user and cuts protruding hairs. A cutting member can be a razor blade with a cutting edge glued, or laser welded, to a separate bent support member. The bent support member can be fitted into a cutting member support slot in-between two opposed cutting member guides, such as protrusions from a transverse frame member of the razor cartridge. The blade can be attached to the face of the bent support member that faces towards a user of the razor cartridge, in use. Alternatively, the blade can be attached to the face of the bent support member that faces away from a user of the razor cartridge, in use. In this latter case, each cutting member has two contact points with the skin of the user (the blade edge, and the distal end of the bent support member), to thus reduce pressure on the user's skin. Alternatively, the cutting member may be a “bent blade”. This is an integrally formed cutting member comprising a radiused bend, and a cutting edge formed at a distal end of the radiused bend. A movable cutting member or a movable bent blade may be a cutting member which is movable in the frame, more specifically in the cutting member support slot, e.g., but not limited to, in a direction perpendicular to the shaving plane. The movable cutting member may be biased by at least one biasing element which is configured to exert a biasing force on the respective cutting member towards the shaving plane, wherein the cutting member is in a rest position. In embodiments, the at least one biasing element may be a plurality of resilient fingers, as will be described below. In a default position, the cutting edges of the cutting members may bear against a corresponding stop portion. A “plurality of cutting members” may consist of the same type of cutting members, or may comprise at least one bent blade, or another type of blade for example.

In the following specification and claims, the term “leading” means the side of the razor head 10 that contacts a portion of a user's skin first, in normal use. In the following specification and claims, the term “trailing” means the side of the razor head 10 that contacts a portion of a user's skin last, in normal use.

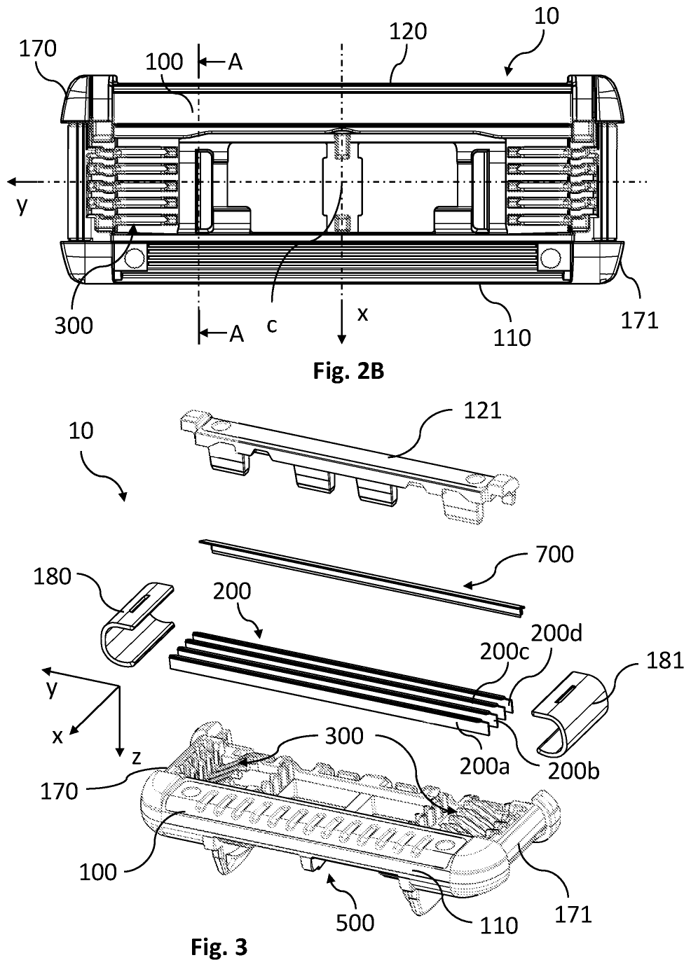

FIGS. 2A, 2B and 3 are a front view, a side view and an exploded view of the razor head 10 according to an aspect of the present disclosure. The razor head 10 comprises a frame 100 having a leading longitudinal member 110 and a trailing longitudinal member 120. A plurality of substantially parallel cutting members 200 is disposed between the leading longitudinal member 110 and the trailing longitudinal member 120. Furthermore, a cutting member support 300 is arranged in the frame 100, wherein the cutting member support 300 is coupled to the plurality of cutting members 200. The cutting member support 300 is configured to displace at least one cutting member 200a-e of the plurality of cutting members 200 from a default position 130 to at least one predetermined deviating position 140 based on an external stimulus, which will be explained in more detail. The at least one cutting member 200a-e of the plurality of cutting members 200 can be displaced by the cutting member support 300 based on the external stimulus, which can lead to increased space (e.g., inter-blade span) between the respective cutting members 200a-e and/or between the cutting members 200a-e and the frame, more specifically between the cutting members 200a-e and the leading longitudinal member 110 and/or the trailing longitudinal member 120. Thereby, better rinsing of cut hair between frame 100 (e.g., leading longitudinal member 110 and/or trailing longitudinal member 120) and cutting members 200a-e, and/or between the respective cutting members 200a-e can be achieved. Furthermore, clogging can be minimized without decreasing shaving performance and/or safety since a spacing, more specifically an inter-blade span which will be described in more detail below, between the respective cutting members 200a-e can be kept narrow when shaving and can be increased when rinsing.

As shown, e.g., in FIGS. 2A and 2B, the razor head 10 comprises a shaving direction x, a perpendicular direction y which is perpendicular to the shaving direction x, and a vertical direction z which is perpendicular to the shaving direction x and the perpendicular direction y.

In embodiments, the cutting member support 300 may be configured to displace at least some cutting members 200a-e of the plurality of cutting members 200 from the default position 130 to the at least one predetermined deviating position 140 based on the external stimulus. As an example, if a number of five cutting members 200a-e are provided, the cutting member support 300 may be configured to displace the first two cutting members 200a, b, with respect to the leading longitudinal member 110 in the shaving direction x, from the default position 130 to the at least one predetermined deviating position 140 based on the external stimulus in the shaving direction x. The other three cutting members 200c,d,e may be configured to stay in the default position 130. In other embodiments, the cutting member support 300 may be configured to displace all cutting members 200a-e of the plurality of cutting members 200 from the default position 130 to the at least one predetermined deviating position 140 based on the external stimulus. However, in this embodiment it is also possible that the cutting members 200a-e are displaced in different directions and/or rotations. In still other embodiments, the cutting member support 300 may be configured to displace every second cutting member 200a,c,e of the plurality of cutting members 200 from the default position 130 to the at least one predetermined deviating position 140 based on the external stimulus. As an example, if a number of five cutting members 200a-e are provided, the cutting member support 300 may be configured to displace the first, third and fifth cutting member 200a,c,e from the default position 130 to the at least one predetermined deviating position 140 based on the external stimulus. The second and fourth cutting member 200b,d may stay in the default position 130. However, it should be noted that the above embodiments and examples are not exhaustive. There are various combinations, each depending on the number of cutting members 200 and the specific shape of the razor head 10.

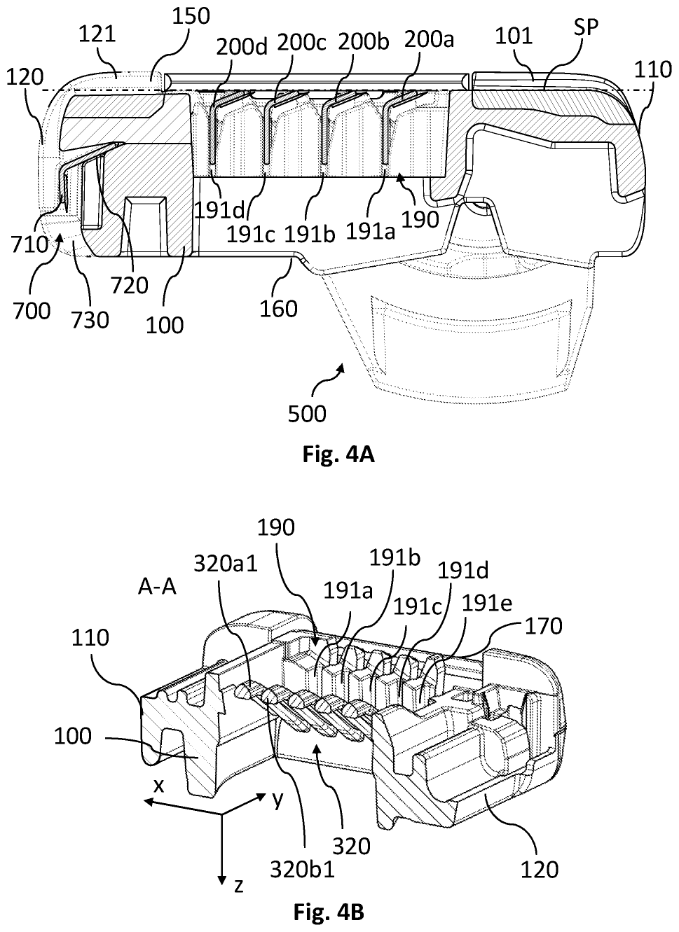

FIGS. 4A and 4B are cut-away views of different sections of the razor head 10 parallel to the x-z plane. The leading longitudinal member 110 defines a leading edge and the trailing longitudinal member 120 defines a trailing edge. As shown in FIG. 4A, the frame 100 comprises a skin-contacting side 150, more specifically wherein the shaving plane SP is defined on the skin-contacting side 150 of the frame 100. The frame 100 further comprises a back side 160, which is opposite the skin-contacting side 150. The shaving direction x and the perpendicular direction y may lie in the shaving plane SP which is on the skin-contacting side 150, or, in a geometric center c of the frame 100. As indicated in FIGS. 2A and 4A, on a back side 160 of the frame 100 opposite the skin-contacting side 150, the frame 100 may comprise the coupling section 500 configured to couple the razor head 10 to the razor handle 20.

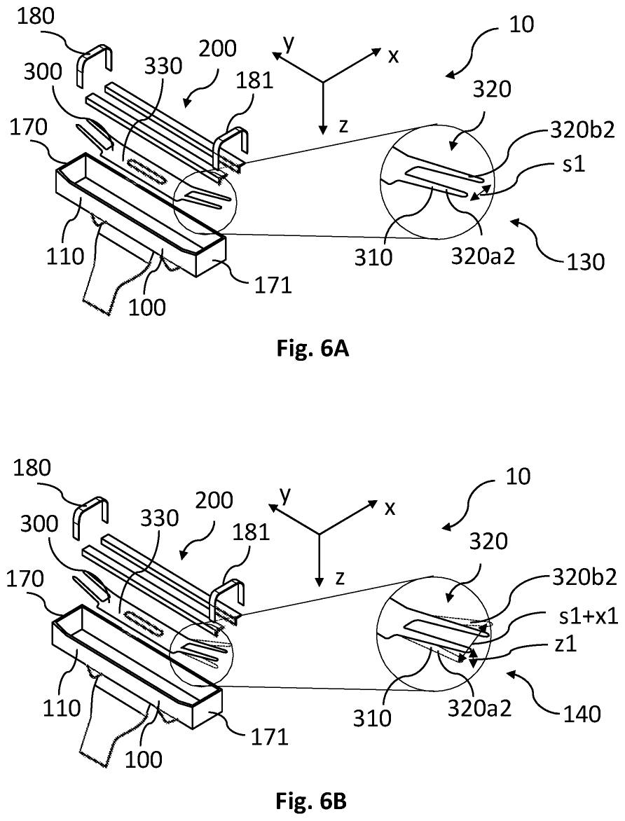

Referring to FIGS. 2A to 3, the frame 100 comprises a first side portion 170 and a second side portion 171, each extending in the shaving direction x between leading longitudinal member 110 and trailing longitudinal member 120 on opposite sides of the leading longitudinal member 100 and the trailing longitudinal member 120, with respect to the perpendicular direction y. As shown, e.g., in FIG. 3, the frame 100 may comprise a first cutting member retainer 180 and a second cutting member retainer 181 configured to be pushed onto the first side portion 170 and the second side portion 171 in the perpendicular direction y, or in the vertical direction z (see, e.g., FIGS. 6A and 6B). In an embodiment, only one cutting member retainer 180 may be provided. The first cutting member retainer 180 and the second cutting member retainer 181 may be configured to retain the plurality of cutting members 200 when inserted in the frame 100, e.g., when inserted in a plurality of cutting member support slots 191a-e as described below. In embodiments, the first cutting member retainer 180 and/or the second cutting member retainer 181 may be C-shaped. In embodiments, the first cutting member retainer 180 and the second cutting member retainer 181 can be connected to the first side portion 170 and the second side portion 171 of the frame 100 by a positively locking connection, respectively.

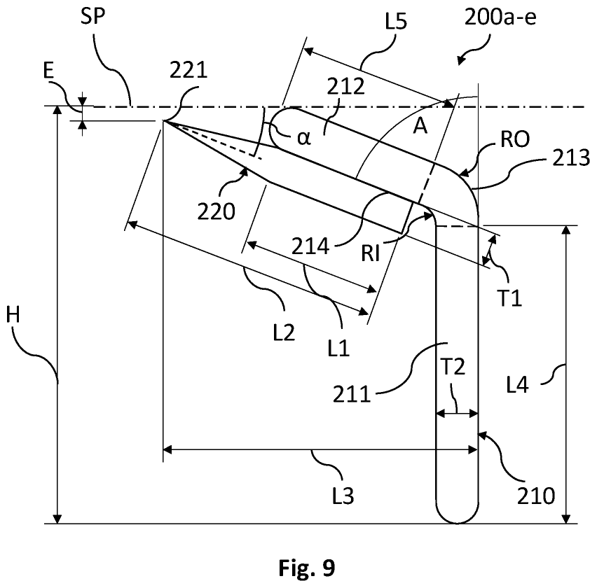

FIGS. 4A and 4B are cut-away views of different sections of the razor head 10 parallel to the x-z plane. As shown in the embodiments of FIGS. 4A and 4B, the frame 100 may comprise a plurality of cutting member guides 190 defining a plurality of cutting member support slots 191a-d. Each cutting member support slot 191a-e may be configured to accommodate a longitudinal cutting member 200a-e of the plurality of cutting members 200. In an embodiment, the first side portion 170 and the second side portion 171 may comprise the plurality of cutting member guides 190. As described above, the frame 100 further comprises a plurality of longitudinal cutting members 200, wherein each cutting member 200a-e can be disposed in a respective cutting member support slot 191a-e. Detailed embodiments of the plurality of cutting members 200 will be described with reference to FIG. 9 below. Although four cutting members 200a-d are shown in FIG. 4A and five cutting member support slots 191a-e (i.e., slots for five cutting members 200a-e) are shown in FIG. 4B, it should be noted that the razor head 10 may comprise at least one cutting member, including but not limited to, one, two, three, four, five, six, seven or more cutting members. In embodiments, the plurality of cutting members 200 may be fixed to the razor head 10, more specifically to the cutting member support 300 of the frame 100. In the default position 130, these cutting members 200a-e may not be movable in the razor head 10, more specifically in the frame 100. In an embodiment, in the default position 130, the cutting members may be fixedly arranged in respective cutting member support slots 191a-e. In other embodiments, in the default position 130, all cutting members 200a-e of the plurality of cutting members 200 may be movable within the razor head 10, more specifically in the respective cutting member support slots 191a-d, or in another embodiment some cutting members of the plurality of cutting members 200 may be movable while others may be fixed.

FIG. 9 is a schematic side view of an embodiment of a cutting member 200a-e of the plurality of cutting members 200. Each cutting member 200a-e of the plurality of cutting members 200 comprises a blade 220a-e having a cutting edge 221a-e. As shown in FIG. 9, the cutting member 200a-e may be a sub-assembly comprising a longitudinal blade 220 mounted on a longitudinal blade support 210. The longitudinal blade support 210 may comprise a substantially elongated lower portion 211, more specifically a flat lower portion 211, which may be suitable for being held in at least one holding slot of the frame 100, a substantially elongated top portion 212, more specifically a flat top portion 212, and a radius bent portion 213. In other embodiments, the flat lower portion 211 may be suitable to be coupled to the cutting member support 300. The bent portion 213 is arranged between the lower portion 211 and the top portion 212 and defines an angle of approach A of the blade 220 with respect to the shaving plane SP. The top portion 212 comprises an inner surface 214. The approach angle A defines the angle of declination of an inner surface 214 of the top portion 212 from the reference of the blade support 211 (more specifically, of the lower portion 211). In an embodiment, A is an acute angle, specifically between 60 and 75 degrees, more specifically between 65 and 70 degrees, in particular 68 degrees. The blade 220 is mounted on the inner surface 214 of the blade support 210, more specifically of the top portion 212. In embodiments, the radius bent portion 213 may have an inner radius of curvature RI of at least 0.1 mm. The radius bent portion 213 may have an inner radius of curvature RI that is less than 0.9 mm. A minimum recommended inner radius of curvature RI of sheet metal should be at least the same as its thickness T2, wherein T2 is the thickness of the blade support 210. A safety factor of the thickness of the blade support 210 may be applied. By multiplying the safety factor with the preferable thickness of T2, the inner radius of curvature RI may be approximately between 0.15 mm and 0.30 mm, more specifically between 0.18 mm and 0.25 mm, and in particular between 0.19 mm and 0.21 mm. The radius bent portion 213 may have an outer radius of curvature RO, which may be approximately between 0.20 mm and 0.50 mm, more specifically between 0.30 mm and 0.40 mm, and in particular between 0.34 mm and 0.36 mm.

In embodiments, the exemplary cutting member 200a-e may comprise a blade support 210 including the top portion 212 having an inner surface 214 that, in use, faces away from the shaving plane SP and a blade 220 attached to the inner surface 214 of the top portion 212. In other words, the blade 220 may be mounted “underneath the blade support 210”. The phrase “underneath the blade support” for the purposes of this specification and claims means a side of the blade support 210 that is furthest from a shaving plane SP (and/or skin) of a user when the razor head 10 is in use. The blade 220 includes a cutting edge 221. In embodiments and as described above, one, two, three, four, five, six, seven or more cutting members 200 may be provided. If a plurality of cutting members 200 are provided, one or more of the cutting members 200 may comprise the blade support 210 including the top portion 212 having an inner surface 214 that, in use, faces away from the shaving plane SP and a blade 220 attached to the inner surface 214 of the top portion 212, as described above. In embodiments, each of the cutting members 200a-e may comprise the blade support 210 including the top portion 212 having an inner surface 214 that, in use, faces away from the shaving plane SP and a blade 220 attached to the inner surface 214 of the top portion 212, as described above.

In an embodiment, the razor head 10 may comprise the plurality of cutting members 200 oriented (and/or configured to shave) in the shaving direction x and/or towards the leading longitudinal member 110.

The inner surface 214 may be a bottom surface of the blade support 210, or in other words, a surface of the blade support 210 which is opposite the top (in particular a top side) of the blade support 210, more specifically of the top portion 212. The phrase “top of the blade support” for the purposes of this specification and claims means a side of a blade support 210 that is closest to a shaving plane SP (and/or skin) of a user when the razor head 10 is in use.

The blade support 210 may be made from a flat sheet metal part which is bent before welding of the blade 220 on the inner surface 214 of the blade support 210 at the top portion 212. The flat sheet metal part may derive from a metal wire which has been flattened i.e. by rolling process. The lower portion 211 may have a length L4 of at least 1.0 mm. In embodiments, the length L4 may be between 1.1 mm and 1.8 mm, more specifically between 1.20 mm and 1.40 mm, in particular between 1.20 mm and 1.25 mm. The top portion 212 may have a length L5 of at least 0.50 mm. In embodiments, the length L5 may be between 0.50 mm and 0.90 mm, more specifically between 0.60 mm and 0.85 mm, in particular between 0.74 mm and 0.80 mm. The blade 220 has a flat connection portion with a thickness T1, which can be about 0.1 mm (for example, between 0.04 and 0.11 mm). In embodiments, the thickness T1 may be between 0.06 mm and 0.09 mm, more specifically between 0.07 mm and 0.08 mm. The total length L2 of the blade 220 between the cutting edge 221 of the blade 220 and an opposite back edge of the blade 220 can be about 1 mm (for example, between 0.8 mm and 1.3 mm). In embodiments, the total length L2 of the blade 220 may be between 0.90 mm and 1.20 mm, more specifically between 1.06 mm and 1.16 mm. The flat connection portion of the blade 220 that is in contact with the inner surface 214 of the top portion 214 of the blade support 210 that, in use, faces away from the shaving plane SP can have a length L1 that is about 0.49 mm+/−0.1 mm long. However, in embodiments, the length L1 can be between 0.30 mm and 0.90 mm, more specifically between 0.40 mm and 0.70 mm. The distance between the cutting edge 221 and a rounded edge of the top portion 212 may be about 0.3 mm, measured parallel to the blade 220, more specifically to the connection portion. In this way, a good retention of the blade on the underside of the blade support 210 (the inner surface 214 of the top portion 212) may be ensured.

In an embodiment, a height H of the exemplary cutting member 200a-e may be between 1.75 mm and 2.00 mm, in particular between 1.84 mm and 1.92 mm. In other embodiments, the height H may be between 2.53 mm and 2.63 mm, particularly about 2.58 mm. In an embodiment, a front end of the blade support 210, more specifically of the top portion 212, may be rounded or chamfered to improve gliding properties of the cutting member 200a-e. In an embodiment, the blade 220 may be positioned on the inner surface 214 of the blade support 210 to adjust an exposure E of the cutting edge 200a-e positively or negatively compared to the shaving plane SP. The exposure is a measure of how prominently the cutting edge 221 of a blade 220 protrudes above or sinks below the end of its blade support 210. In an embodiment, the blade 220 may be positioned to have an exposure E relative to the shaving plane SP in the range of −80 μm to +80 μm, specifically an exposure of about −75 μm, −65 μm, −60 μm, −55 μm, −50 μm, −45 μm, −40 μm, −35 μm, −30 μm, −25 μm, −20 μm, −15 μm, −10 μm, −5 μm, 0 μm, 5 μm, 10 μm, 15 μm, 20 μm, 25 μm, 30 μm, 35 μm, 40 μm, 45 μm, 50 μm, 55 μm, 60 μm, 65 μm, 70 μm, or 75 μm. A length L3 of the cutting member 200a-e, measured between the cutting edge 221 and an outer face of the lower portion 211 of the blade support 210 may be about 1.0 mm (for example, between 0.9 mm and 1.6 mm). The blade 220 may be fixed on the inner surface 214 of the blade support 210 by any known means, such as but not limited to, by laser spot welding. In embodiments, the blade 220 may be fixed on the inner surface 214 of the blade support 210 by a plurality of spot welds (for example, between ten and sixteen spot welds) distributed along the longitudinal dimension of the blade support 210. Each of the spot welds may be performed on the inner face of the blade. Alternatively, each of the spot welds may be carried out on the outer surface of the blade support 210, or a mixture of the two.

When shaving, the blade support(s) 210 of the cutting members 200a-e may be brought into contact with the skin (shaving plane SP) in addition to the cutting edges 221 of the blade 220. Therefore, the number of contact points between the razor head 10 and the skin can be increased, up to being doubled. The amount of pressure exerted on a portion of skin by each cutting edge 221 can be significantly reduced, leading to fewer incidents of skin injury (“nicking”) and a more comfortable shave. The blade 220 may be mounted on an inner surface 214 of the blade support 210 to enable the blade support 210 to simultaneously contact the skin at the same time as the cutting edge 221 of the blade 220, in use. This means that the portions of the blade support 210 in contact with the skin reduce or minimize the “skin bulge”, thus reducing the risk of nicks and cuts occurring. Another effect is that durability of the blades can be prolonged, since less pressure is applied to the skin thus resulting in a less aggressive shaving and therefore the blades can wear at a lower rate. Although a specific cutting member 200a-e comprising a blade support 210 attached to a blade 220 has been described, it should be noted that in other embodiments, the cutting members 200a-e may only comprise the blade 220 coupled to the cutting member support 300, but which may not have the blade support 210.

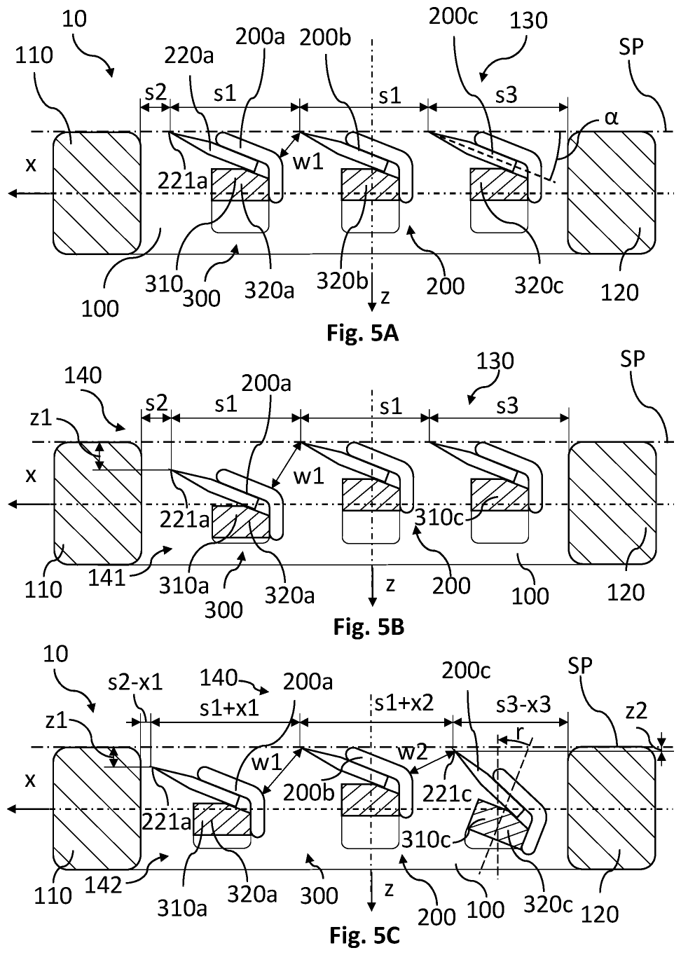

FIGS. 5A to 5C are cut-away views of the razor head 10 showing the default position 130 and different predetermined deviating positions 140 of the plurality of cutting members 200. The cutting member support 300 may comprise at least one responsive shape-shift component 310, which is configured to perform a shape-shift from the default position 130 to the at least one predetermined deviating position 140 based on the external stimulus. In an embodiment, the at least one responsive shape-shift component 310 may comprise a responsive shape-shifting polymer. For this specification and claims, the term “responsive shape-shift” describes the ability of an object to change/shift its shape as a result of an external stimulus applied on the object. The at least one responsive shape-shift component 310 of the cutting member support 300 can change/shift its shape based on the external stimulus. In other words, the at least one responsive shape-shift component 310 may comprise one or more properties that can be significantly changed in a controlled manner by an external stimulus. The external stimulus may be, or a variation of, temperature, stress, moisture, electric or magnetic fields, light, pH or chemical compounds. In an embodiment, the external stimulus may be a temperature variation. In another embodiment, the external stimulus may be a moisture variation. In still another embodiment, the external stimulus may be a combination of a temperature variation and a moisture variation. This may be the case, for example, when the user rinses the razor head 10 with hot water after shaving or during a shaving operation. Both stimuli (temperature variation and moisture variation) may thereby be activated simultaneously. However, in embodiments, it is also possible that both stimuli are activated, but the associated shape-shifts occur at different time points. The at least one shape-shift component 310 can memorize and/or retain two or three different shapes, wherein the transition between these shapes is based on the external stimulus. The shape-shift effect can be described by a strain recovery rate Rr and a strain fixity rate Rf. The strain recovery rate Rr defines the ability of the at least one shape-shift component 310 to memorize its permanent shape, i.e., the shape, the at least one responsive shape-shift component 310 of the cutting member support 300 comprises in the default position 130. In embodiments, the strain recovery rate Rr may be larger than 85%, more specifically larger than 90%. It should be noted, that the strain recovery rate Rr may decrease, when an applied strain c on the at least one responsive shape-shift component 310 increases. Consequently, a strain recovery rate Rr larger than 90% at a maximum strain of ε<80% may be desirable to avoid altering an angle of inclination a (see, explanation below) of the respective cutting members 200a-e with respect to the shaving plane SP when mounted to the cutting member support 300, and/or inter-blade spans s1, s2, s3 between the respective cutting members 200a-c, when performing a shaving operation. The strain fixity rate Rf describes the ability of the at least one responsive shape-shift component 310 of shifting some of its segments to fix a predetermined mechanical deformation, which the at least one responsive shape-shift component 310 comprises in the at least one predetermined deviating position 140. In embodiments, the strain fixity rate Rf may be between 80% to 99%, more specifically between 85% to 95%. Since the cutting member support 300 is coupled to plurality of cutting members 200, at least one cutting member 200a-e of the plurality of cutting members 200 can be displaced, due to the shape-shift of the at least one responsive shape-shift component 310, from the default position 130 to the predetermined deviating position 140. In an embodiment, the responsive shape-shift component 310 can comprise a responsive shape-shifting polymer combined with (thermally) responsive liquid crystal elastomers (LCEs) that can change their shape back and forth according to an external stimulus, more specifically a temperature, applied.

As shown, e.g., in FIGS. 5A to 5C, the at least one responsive shape-shift component 310 is coupled to the at least one cutting member 200a-e of the plurality of cutting members 200 that is displaceable from the default position 130 to the at least one predetermined deviating position 140. In embodiments, the at least one responsive shape-shift component 310 is coupled to a side of the at least one cutting member 200a-e facing towards the geometric center c of the frame 100, more specifically in the vertical direction z. In other words, the at least one responsive shape-shift component 310 may be configured to perform a shape-shift and may be arranged in contact with or proximate the at least one cutting member 200a-e of the plurality of cutting members 200.

FIGS. 5A to 5C show embodiments, wherein the frame 100 comprises three cutting members 200a-c. In FIG. 5A, viewed from the leading longitudinal member 110 in the shaving direction x towards the trailing longitudinal member 120, the cutting member support 300 which supports the first cutting member 200a comprises the responsive shape-shift component 310. In FIG. 5A, each of the cutting members 200a-c is in the default position 130.

The default position 130 may be provided such that a shaving performance of the plurality of cutting members 200 is increased. As shown in FIG. 5A, in the default position 130, the plurality of cutting members 200 defines a plurality of substantially parallel first inter-blade spans s1. The inter-blade spans s1 can be measured parallel to the shaving direction x between the respective cutting edges 221a-e of the plurality of cutting members 200. More specifically, the shaving performance may be increased due to a small inter-blade span s1 between cutting edges 221a-e of the cutting members 220a-e in the default position 130. The term “inter-blade span” is herein defined as the span between two adjacent cutting edges 221a-e. The cutting members 200a-e are drawn across the skin of the user so that the skin is contacted by the cutting-edge plane. A close inter-blade span s1 may lead to hairs being shaved very close or below the skin surface, which may increase the risk of hairs becoming trapped. Increasing the inter-blade span s1 may lead to increased bulging, which may lead to an increased skin irritations and cuts, in particular if skin bumps are present. Referring to FIGS. 5A and 9, in the default position 130, each cutting member 200a-e of the plurality of cutting members 200 may have an angle of inclination a with respect to the shaving plane SP, which may be between 15° to 45°, more specifically between 20° to 35°. In detail, the angle of inclination a can be measured between a line, extending through the cutting edge 221a-e and parallel to each of the respective blades 220a-e in the x-z plane, and the shaving plane SP.

In the default position 130, a second span s2, measured parallel to the shaving direction x, may be defined between leading longitudinal member 110 and a cutting edge 221a-e of a cutting member 200a-e, which is disposed adjacent the leading longitudinal member 110 (see, cutting member 200a in FIG. 5A). Furthermore, in the default position 130, a third span s3 measured parallel to the shaving direction x may be defined between trailing longitudinal member 120 and a cutting edge 221a-e of a cutting member 200a-e, which is disposed adjacent the trailing longitudinal member 120 (see, e.g., cutting member 200c in FIG. 5A). In embodiments, in the default position 130, the spans s2, s3 between frame and adjacent cutting edges, and/or the inter-blade spans s1 between the respective cutting edges 221a-e may be constant. In other embodiments, the spans s2, s3 may vary between the frame 100 and adjacent cutting edges 221a-e, and/or the inter-blade spans s1 may vary between the respective cutting edges 221a-e.

In the default position 130, the plurality of cutting members 200, more specifically the cutting edges 221a-e of the plurality of cutting members 200, may be arranged in or proximate the shaving plane SP. In embodiments, in the default position 130, exposure E of the cutting edges 221a-e (or at least one cutting edge 221a-e) can be adjusted positively or negatively compared to the shaving plane SP.

Referring to FIGS. 5B and 5C, starting from the default position 130, the cutting member support 300 is configured to displace the at least one cutting member 200a-e of the plurality of cutting members 200 in the shaving direction x and/or in the vertical direction z and/or by a rotation r about an axis defined by the perpendicular direction y, based on the external stimulus. The at least one predetermined deviating position 140 is provided, such that rinsing between the plurality of cutting members 200, and/or between the plurality of cutting members 200 and the leading longitudinal member 110, and/or between the plurality of cutting members 200 and the trailing longitudinal member 120, is improved. In other words, since the cutting members 200a-e can be displaced either in the shaving direction x and/or in the vertical direction z and/or by a rotation r based on the external stimulus, additional space between the cutting members 200a-e and/or the leading longitudinal member 110 and/or the trailing longitudinal member 120 can be provided, such that rinsing between the cutting members 200a-e can be simplified. The cutting members 200a-e can be displaced from the default position 130 to the at least one predetermined deviating position 140 through flexion, bending angle, twisting of the cutting member support 300, or a combination thereof.

Starting from the default position 130, the cutting member support 300 may be configured to displace the at least one cutting member 200a-e of the plurality of cutting members 200 in the shaving direction x towards the leading longitudinal member 110 or towards the trailing longitudinal member 120 by an axial distance x1, measured from the respective cutting edge 221a-e of the at least one cutting member 200a-e in the shaving direction x. The axial distance x1 may be between 0 μm and 1500 μm, more specifically between 0 μm and 1100 μm. The same applies to axial distances x2 and x3, which will be described in more detail below. In the embodiment as shown FIG. 5C, the first cutting member 200a is in a predetermined deviating position 140 and is displaced in the shaving direction x towards the leading longitudinal member 110. The inter-blade span s1 between first cutting member 200a and second cutting member 200b, which is in the default position 130, is thus increased by axial distance x1. However, in this embodiment, the span s2 is decreased by axial distance x1.

Starting from the default position 130, the cutting member support 300 may be configured to displace the at least one cutting member 200a-e of the plurality of cutting members 200 in the vertical direction z towards the back side 160 of the frame 100 by a vertical distance z1, measured from the cutting edge 221a-e of the at least one cutting member 200a-e in the vertical direction z. The vertical distance z1 may be between 0 μm and 1500 μm, more specifically between 0 μm and 1100 μm. The same applies to vertical distance z2, which will be described in more detail below. In the embodiment shown in FIGS. 5B and 5C, the first cutting member 200a is in a predetermined deviating position 140 and is displaced in the vertical direction z towards the back side 160 of the frame 100 by vertical distance z1. In FIG. 5B, the spans s1, s2 and s3 measured in the shaving direction x are constant, as compared to the default position 130. However, due to the displacement in the vertical direction z, a narrowest cross-section w1 between adjacent cutting members 200a-e can be increased, which can lead to simplified rinsing. The narrowest cross-section w1 may be defined between adjacent cutting members 200a-e, more specifically between the cutting edge 221a-e of a cutting member 200a-e and a nearest portion of an adjacent cutting member 200a-e and/or the frame 100, in particular the leading longitudinal member 110 and/or the trailing longitudinal member 120. The same applies to narrowest cross-section w2. In the embodiments shown in FIGS. 5A and 5B, the narrowest cross-section w1 may be measured between cutting edge 221b and a side of the blade support 210 facing towards the shaving plane SP, more specifically proximate the radius bent portion 213. In FIGS. 5B and 5C, in the at least one predetermined deviating position 140, the narrowest cross-section w1 between first and second cutting members 200a,b is larger than in the default position 130, shown e.g., in FIG. 5A.

As shown in FIG. 5C, starting from the default position 130, the cutting member support 300 may be configured to displace the at least one cutting member 200a-e of the plurality of cutting members 200 by a rotation about an axis defined by the perpendicular direction y (or which is parallel to the perpendicular direction y), wherein the rotation can be defined by a rotation angle r. In embodiments, the rotation angle r may be between −20°<r<+20°, in particular wherein the rotation angle r may be between −5°<r<+5°, measured from the default position 130 to the at least one predetermined deviating position 140.

In the at least one predetermined deviating position 140, at least one of the first inter-blade spans s1, second span s2 and third span s3 may be larger or smaller than in the default position 130, depending on the axial distances x1, x2, x3, vertical distances z1, z2 and/or rotation angle r. In other words, the change of the respective spans depends on axial distances x1, x2, x3 vertical distances z1, z2 and/or rotation angle r. Referring to the embodiment shown FIG. 5C, the first cutting member 200a and the third cutting member 200c are in the at least one predetermined deviating position 140 and displaced as compared to the default position 130. In FIG. 5C, the first cutting member 200a is displaced in the vertical direction z by vertical distance z1 and towards the leading longitudinal member 110 by axial distance x1. The third cutting member 200c is rotated towards the trailing longitudinal member 120 by rotation angle r and displaced in the vertical direction z by vertical distance z2. It should be understood, that due to the rotation, cutting member 200c is also displaced in the shaving direction x by axial distance x3. An inter-blade span s1 between second and third cutting members 200b,c can be increased by axial distance x2. If the cutting member 200b maintains its position (as shown in FIG. 5C), the axial distance x2 can be equal to axial distance x3. Furthermore, span s3 between third cutting member 200c and trailing longitudinal member 120 is decreased by axial distance x3.

As shown in FIG. 5C, a narrowest cross-section w2 is measured between second cutting member 200b and third cutting member 200c. In this embodiment, the narrowest cross-section w2 is smaller than the narrowest cross-section w1.

In embodiments, the external stimulus can be a temperature variation. In other words, the at least one responsive shape-shift component 310 of the cutting member support 300 is responsive to a temperature variation (i.e., the shape-shift may be triggered by the temperature variation). In embodiments, the temperature may vary between 18° C. and 50° C. In a first temperature range of about 18° C. to 25° C., the plurality of cutting members 200 may be in the default position 130. In a second temperature range of about 25° C. to 50° C., the at least one cutting member 200a-e of the plurality of cutting members 200 may be displaced from the default position 130 to the at least one predetermined deviating position 140. When the temperature increases from the first temperature range to the second temperature range, the at least one responsive shape-shift component 310 of the cutting member support 300 may perform a shape-shift to the at least one predetermined deviating position 140, however, which may be instantaneous and reversible (similar to a bistable mechanism). When the temperature is decreasing from the second temperature range to the first temperature range, the at least one responsive shape-shift component 310 of the cutting member support 310 may perform a shape-shift from the at least one predetermined deviating position 140 back to its original shape, such that each of the plurality of cutting members 200 is in the default position 130. In other words, the at least one responsive shape-shift component 130 of the cutting member support 300 is mechanically programmed to perform a shape-shift based on the temperature variation.

In embodiments, the at least one responsive shape-shift component 310 of the cutting member support 300 can be configured to perform a first shape-shift from the default position 130 to a first predetermined deviating position 141 at a first transition temperature. The first transition temperature may be between 24° C. and 28° C. Compared to the default position 130, the first predetermined deviating position 141 may be displaced by axial distance x1, vertical distance z1 and/or a rotation angle r. In embodiments, the at least one responsive shape-shift component 310 of the cutting member support 300 may be configured to perform a second shape-shift from the first predetermined deviating position 141 to a second predetermined deviating position 142 at a second transition temperature. The second transition temperature may be higher than the first transition temperature, in particular wherein the second transition temperature may be between 37° C. and 42° C. Compared to the first predetermined deviating position 141, the second predetermined deviating position 142 may be arranged in such a way that the axial distance x1, the vertical distance z1 and/or the rotation angle r are larger (or smaller) then in the first predetermined deviating position 141. Such an embodiment can be illustrated by FIGS. 5A to 5C with respect to cutting members 200a and 200c. The cutting member support 300 is coupled to cutting member 200a and comprises a responsive shape-shift component 310a in contact with or proximate the cutting member 200a. In FIG. 5A, the cutting member support may be at room temperature (e.g., at a temperature of about 21° C.), wherein the cutting members 200a-c are in the default position 130. In FIG. 5B, the cutting member support 300 is at the first transition temperature and performs a shape-shift to the first predetermined deviating position 141, wherein, compared to the default position 130, the first cutting member 200a is displaced by vertical distance z1. However, cutting members 200b, 200c may stay in the default position 130. In FIG. 5C, the cutting member support 300 exceeds the second transition temperature and performs a second shape-shift to the second predetermined deviating position 142, wherein, compared to the first predetermined deviating position 141, the first cutting member 200a is displaced by axial distance x1 towards the leading longitudinal member 110. The cutting member support 300 is also coupled to the cutting member 200c and may comprise a responsive shape-shift component 310c being in contact with or proximate the cutting member 200c. However, the shape-shift component 310c may perform its shape-shift at a transition temperature (e.g., the second transition temperature) that is different from the first transition temperature of the responsive shape-shift component 310a being in contact with or proximate cutting member 200a. Referring to FIG. 5B, even if the first transition temperature is reached, the cutting member 200c may stay in the default position 130. As stated above, in FIG. 5C the cutting member support 300 exceeds the second transition temperature and the shape-shift component 310c may additionally perform a shape-shift, wherein the cutting member 200c is displaced by vertical distance z2, by axial distance x3 towards the trailing longitudinal member 120, and by rotation angle r.

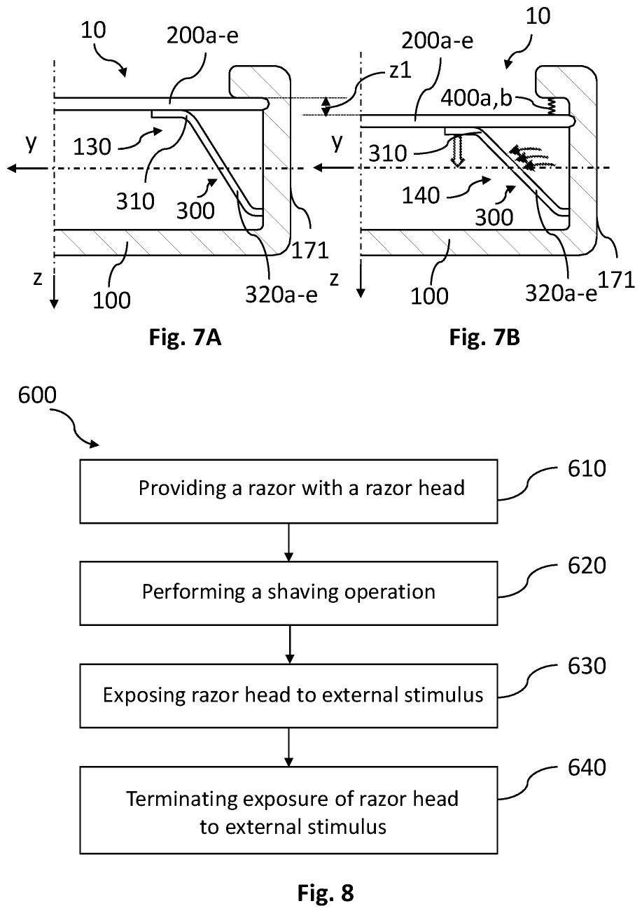

FIGS. 6A and 6B are schematic views of the razor head 10 showing a first embodiment of the cutting member support 300. FIGS. 4B, 7A and 7B are schematic views of the razor head 10 showing a second embodiment of the cutting member support 300. As shown in these Figs., the cutting member support 300 may comprise a plurality of resilient fingers 320. A pair of fingers 320a1, 320a2 of the plurality of fingers 320 may be coupled to a cutting member 200a-e of the plurality of cutting members 200, respectively. However, in embodiments, it may also be possible that more than two fingers 320 are coupled to each cutting member 200a-e of the plurality of cutting members 200. It should be noted, that the number of fingers 320 may be related to the number of cutting members 200a-e disposed in the frame 100. In the embodiment shown in FIG. 4B, five cutting members 200a-e may be disposed in the frame, such that the cutting member support 300 may comprise ten resilient fingers 320, wherein in each case a pair of fingers is coupled to one cutting member 200a-e. In the embodiment shown in FIGS. 6A and 6B, two cutting members 200a,b are provided, such that the cutting member support 300 comprises four resilient fingers 320. In the default position 130, the resilient fingers 320 may allow the cutting members 200a-e to flex slightly in vertical direction z during a shaving operation (i.e., when a force is applied on the razor head 10, more specifically on the cutting members 200a-e), allowing the cutting members 200a-e to better adapt to the skin contour, which may lead to improved shaving performance.

Each pair of fingers 320a1, 320a2 may be in corresponding alignment in the perpendicular direction y, as shown, e.g., in FIGS. 6A and 6B. At least one pair of fingers 320a1, 320a2 of the plurality of fingers 320 comprises the responsive shape-shift component 310 of the cutting member support 300 configured to perform the shape-shift based on the external stimulus. In other words, each finger of the at least one pair of fingers 320a1, 320a2, may comprise the responsive shape-shift component 310. It should be noted that the displacement of the respective cutting members 200a-e occurs due to the shape-shift of the at least one responsive shape-shift component 310. As the cutting members 200a-e are coupled to the plurality of fingers 320, with at least one pair of fingers 320a1, 320a2 comprising the at least one shape-shift component 310, the cutting member 200a coupled to these fingers follows the shape-shift and is thus displaced. As described above, the shape-shift may occur for at least one, every second, some, all or other combinations of cutting members 200a-e, depending on the number of cutting members. Furthermore, the shape-shift of the cutting member support 300, more specifically of the fingers 320 comprising the at least one responsive shape-shift component 310, may occur at different transition temperatures for at least one, some, all or any other combination of cutting members 200a-e. In other words, in embodiments, each of the cutting members 200a-e may be displaced to different locations, depending on individual transition temperature, mechanically programmed shape-shift of the responsive shape-shift component 320 and the specific cutting members 200a-e being supported by the fingers 320 with the responsive shape-shift component 310. In the embodiment shown in FIGS. 6A and 6B, each finger of the plurality of resilient fingers 320 contacts the respective cutting members 200a,b and comprises the responsive shape-shift component 310. In embodiments, the cutting member support 300, more specifically each pair of fingers of the plurality of resilient fingers 320, may be coupled to the plurality of cutting members 200 by positive locking, non-positive locking, or adhesive bonding.

In the default position 130, each finger 320a-e of the plurality of resilient fingers 320 may be configured to exert a bias force against the plurality of cutting members 200 in the vertical direction z towards the shaving plane SP. In the default position 130, the plurality of cutting members 200 may bear against corresponding stop portions, more specifically wherein the stop portions can be the first cutting member retainer 180 and the second cutting member retainer 181, when assembled. In other embodiments, the stop portions can also be parts of the frame 100, more specifically first and second side portions 170, 171. Accordingly, the default position 130 of the cutting members 200a-e can be well defined, enabling a high shaving precision.

In the second embodiment shown in FIGS. 4B, 7A and 7B, each pair of fingers 320a1, 320a2 of the plurality of fingers 320, extends substantially in the perpendicular direction y from the first side portion 170 and the second side portion 171 towards a geometric center c of the frame 100, respectively. When assembled, the plurality of fingers 320 may be arranged below the first retainer 180 and the second retainer 181. FIG. 4B shows five subsequent fingers. As an example, fingers 320a1, 320b1 support different cutting members 200a, 200b. Cutting member 200a is supported by two fingers 320a1, 320a2, which together form a pair of fingers. Finger 320a1 extends from the first side portion 170 in the perpendicular direction y towards center c, as shown in FIG. 4B. Finger 320a2 extends from the second side portion 171, which is opposite the first side portion 170 in the perpendicular direction y from which finger 320a1 extends (and which is not shown in FIG. 4B). In other words, the fingers 320a1, 320a2 are aligned in the perpendicular direction y and extend from opposite side portions 170, 171. Cutting member 200b is supported by two fingers 320b1, 320b2, which also form a pair of fingers extending on opposite sides in the perpendicular direction y.

In the first embodiment shown in FIGS. 6A and 6B, the cutting member support 300 comprises a base portion 330 that is attached to the frame 100 proximate the (geometric) center c of the frame 100. In this embodiment, the plurality of fingers 320 may extend from the base portion 330 in the perpendicular direction y towards the first side portion 170 and the second side portion 171, respectively.

As described above, in embodiments, the first side portion 170 and the second side portion 171 may comprise a plurality of cutting member guides 190 defining a plurality of cutting member support slots 191a-e, each configured to accommodate a cutting member 200a-e of the plurality of cutting members 200, wherein each cutting member 200a-e is disposed in a respective cutting member support slot (see, e.g., FIGS. 4A and 4B). In this embodiment, it should be noted that the cutting member support 300 may be configured to displace the cutting members 200a-e only in the vertical direction z, i.e., in the direction, the cutting member slots 191a-e extend. The cutting member support slots 191a-e may serve as a guide for the cutting members 200a-e for the direction of displacement. However, in other embodiments, the cutting member support slots 191a-e may be provided under an angle with respect to the vertical direction z, i.e. extending from a position proximate the shaving plane SP under an angle towards the back side 160 of the frame 100. In this embodiment, the at least one cutting member 200a-e may be guided and displaced from the default position 130 to the at least one predetermined deviating position 140 only in the direction of cutting member support slots 191a-e.

In an embodiment as described above, the cutting members 200a-e may be coupled by a rigid connection to the cutting member support 300, more specifically to the respective fingers 320. However, in other embodiments, the coupling between the cutting member support 300 and the cutting members 200a-e may be configured such that the cutting members 200a-e merely rest on the fingers 320. Such an embodiment is shown in FIGS. 7A and 7B. The razor head may further comprise at least two spring elements 400a, 400b arranged adjacent the first side portion 170 and the second side portion 171, respectively, between the plurality of cutting members 200 and the frame 100. In embodiments, the at least two spring elements may be arranged between the plurality of cutting members 200 and first cutting member retainer 180 and the second cutting member retainer 181, respectively. The at least two spring elements 400a, 400b may be configured to exert a bias force in the vertical direction z towards the center c of the frame 100. In other words, the at least two spring elements 400a, 400b may exert a bias force which is substantially opposite the bias force provided by the plurality of resilient fingers 320. However, in the default position 130, the bias force of the at least two spring elements 400a, 400b may be lower than the bias force of the plurality of resilient fingers 320. Consequently, in the default position 130, the plurality of cutting members 200 can thus bear against the frame 100, more specifically against first and second side portions 170, 171 and/or against first and second cutting member retainers 180, 181. In other words, in the default position 130, a stiffness of the at least two spring elements 400a, 400b may be lower than a stiffness of the plurality of resilient fingers 320.

As shown in FIG. 7B, when the at least one responsive shape-shift component 310 performs a shape-shift from the default position 130 to the at least one predetermined deviating position 140 based on the external stimulus, the at least two spring elements 400a, 400b push the at least one cutting member 200a-e of the plurality of cutting members 200 towards the plurality of fingers 320 in the vertical direction z. The movement of the fingers 320 is indicated by the arrows shown in FIG. 7B. The at least one cutting member 200a-e is thereby displaced from the default position 130 to the at least one predetermined deviating position 140 by vertical distance z1. It should be noted that in this embodiment, the cutting members 200a-e can be guided in the cutting member support slots 191a-e. It is not necessary to rigidly connect the cutting members 200a-e to the fingers 320. Consequently, the coupling of cutting member support 300 and cutting members 200a-e can be also provided by forming contact between these components.

In embodiments, as shown in FIGS. 3 and 4A, the trailing longitudinal member 120 may comprise a longitudinal skin care element 121 (e.g. a lubricating strip) for applying a compound, such as a lubricating compound, to the shaving plane SP after the plurality of cutting members 200 have passed over a user's skin. The leading longitudinal member may comprise a guard member 101 which may be located proximate the shaving plane SP. The guard member 101 can comprise an elastomeric member (not shown in FIGS. 3 and 4A). The elastomeric layer may comprise one or more fins extending longitudinally in parallel to the guard member 101 and substantially perpendicularly to the shaving direction x. One purpose of such an elastomeric layer is, for example, to tension the skin prior to cutting.

In embodiments, the trailing longitudinal member 120 can further comprise a trimming assembly 700, more specifically a longitudinal trimming assembly 700, provided on the trailing edge. A skilled person will appreciate that the example trimming assembly 700 may be omitted without loss of generality. The trimming assembly 700 can comprise a longitudinal trimming cutting member 710 disposed on the trailing edge of the razor head 10. The trimming cutting member 710 may, for example, be used for trimming hairs that are awkward to reach using the plurality of cutting members 200, such as extraneous nasal hairs, or to be able to improve shaving beard contours. The trimming assembly 700 may further comprise a trimming cutting member support slot 720 which is configured to accommodate the trimming cutting member 710. As shown in FIG. 4A, the trimming cutting member 710 is disposed in the trimming cutting member support slot 720. In an embodiment, the trimming cutting member 710 can only extend across a proportion of the longitudinal direction of the trimming assembly 700, such as up to three quarters, up to one half, or up to one quarter. The trimming cutting member 710 may have an identical design with respect to cutting members 200 in order to reduce parts variation.

Alternatively, the trimming cutting member 700 can have a different design to the design of the cutting members 200. The trimming cutting member 710 is not comprised within the plurality of cutting members 200 intended to contact the shaving plane SP. More specifically, the trimming cutting member 410 may be oriented with its cutting edge toward the back side 160 of the razor head in the vertical direction z. In an embodiment, the trimming assembly 700 may comprise a retractable cover 730 as a safety feature, and to keep the trimming cutting member 710 sharp when not in use.

According to another aspect of the present disclosure, a kit of parts is provided (not shown in the Figs.). The kit of parts comprises a razor head holder comprising a plurality of razor heads 10 according to any one of the embodiments described above. In an embodiment, the kit of parts may further comprise a razor handle 20.

According to a fourth aspect of the present disclosure, a method 600 of operating a razor 1 is provided. As shown in FIG. 8, the method 600 comprises the step of providing 610 a razor 1 comprising a razor head 20 as described in any one of the above embodiments. Furthermore, the method 600 comprises the steps of performing a shaving operation 620 with the razor 1, wherein the razor head 10 is configured to cut hair of a user U. Then, the method comprises the step of exposing 630 the razor head 10 to an external stimulus, wherein the cutting member support 300 is configured to displace at least one cutting member 200a-e of the plurality of cutting members 200 from a default position 130 to at least one predetermined deviating position 140 based on the external stimulus. Finally, the method comprises the step of terminating 640 the exposure of the razor head 10 to an external stimulus, wherein the cutting member support 300 is configured to replace the at least one cutting member 200a-e of the plurality of cutting members 200 from the at least one predetermined deviating position 140 to the default position 130. Subsequently, a user may stop shaving, or may repeat a shaving operation as described above. Due to the displacement of at least one cutting member 200a-e of the plurality of cutting members 200, a spacing (inter-blade span and/or distance to the shaving plane SP in axial and/or vertical direction) between the respective cutting members can be temporarily increased such that a rinsing/unclogging of the razor head 10 can be simplified. This can be done without compromising the shaving performance that originates from having the cutting members at a close distance to each other.

In embodiments, the external stimulus may be a temperature variation and/or a moisture variation. The shaving operation may be performed at a first temperature range. Exposing 630 the razor head 10 to an external stimulus may comprise rinsing the razor head 10 with a liquid at a second temperature range, more specifically wherein the second temperature range may be higher than the first temperature range. When the user terminates exposing the razor head 10 to the second temperature range, the temperature may return to the first temperature range, wherein the at least one cutting member 200a-e of the plurality of cutting members 200 is returned to the default position 130.

Although the present disclosure has been described above and is defined in the attached claims, it should be understood that the disclosure may alternatively be defined in accordance with the following embodiments:
1. A razor head (10), comprising:
   a frame (100) comprising a leading longitudinal member (110) and a trailing longitudinal member (120),
   a plurality of substantially parallel cutting members (200) disposed between the leading longitudinal member (110) and the trailing longitudinal member (120), and
   a cutting member support (300) arranged in the frame (100), wherein the cutting member support (300) is coupled to the plurality of cutting members (200),
   characterized in that the cutting member support (300) is configured to displace at least one cutting member (200a-e) of the plurality of cutting members (200) from a default position (130) to at least one predetermined deviating position (140) based on an external stimulus.
2. The razor head (10) according to embodiment 1, wherein the cutting member support (300) comprises at least one responsive shape-shift component (310), which is configured to perform a shape-shift from the default position (130) to the at least one predetermined deviating position (140) based on the external stimulus.
3. The razor head (10) according to embodiment 2, wherein the at least one responsive shape-shift component (310) comprises a responsive shape-shifting polymer.
4. The razor head (10) according to embodiment 3, wherein the responsive shape-shifting polymer is combined with responsive liquid crystal elastomers (LCE) that are adapted to change their shape back and forth according to the external stimulus applied.
5. The razor head (10) according to any one of embodiments 2 to 4, wherein the at least one responsive shape-shift component (310) is coupled to the at least one cutting member (200a-e) of the plurality of cutting members (200) that is displaceable from the default position (130) to the at least one predetermined deviating position (140), more specifically wherein the at least one responsive shape-shift component (310) is coupled to a side of the at least one cutting member (200a-e) facing towards a center (c) of the frame (100).
6. The razor head (10) according to any one of the preceding embodiments, wherein the default position (130) is provided such that shaving performance by the plurality of cutting members (200) is increased.
7. The razor head (10) according to any one of the preceding embodiments, wherein the at least one predetermined deviating position (140) is provided, such that rinsing between the plurality of cutting members (200), and/or between the plurality of cutting members (200) and the leading longitudinal member (110), and/or between the plurality of cutting members (200) and the trailing longitudinal member (120), is improved.
8. The razor head (10) according to any one of the preceding embodiments, wherein the razor head (10) comprises a shaving direction (x), a perpendicular direction (y) which is perpendicular to the shaving direction (x), and a vertical direction (z) which is perpendicular to the shaving direction (x) and the perpendicular direction (y).
9. The razor head (10) according to any one of the preceding embodiments, wherein the frame (100) comprises a skin-contacting side (150) defining a shaving plane (SP), and wherein the frame (100) comprises a back side (160) opposite the skin-contacting side (150).
10. The razor head (10) according to any one of the preceding embodiments, wherein each cutting member (200a-e) of the plurality of cutting members (200) comprises a blade (220a-e) having a cutting edge (221a-e).
11. The razor head (10) according to embodiment 9 and embodiment 10, wherein in the default position (130), the plurality of cutting members (200), more specifically the cutting edges (221a-e) of the plurality of cutting members (200), are arranged in or proximate the shaving plane (SP).
12. The razor head (10) according to any one of embodiments 8 to 11, wherein, starting from the default position (130), the cutting member support (300) is configured to displace the at least one cutting member (200a-e) of the plurality of cutting members (200) in the shaving direction (x) and/or in the vertical direction (z) and/or by a rotation (r) about an axis defined by the perpendicular direction (y), based on the external stimulus.
13. The razor head (10) according to embodiment 12, when dependent on embodiment 8, wherein, starting from the default position, the cutting member support (300) is configured to displace the at least one cutting member (200a-e) of the plurality of cutting members (200) in the shaving direction (x) towards the leading longitudinal member (110) or towards the trailing longitudinal member (120) by an axial distance (x1), wherein the axial distance (x1) is between 0 μm and 1500 μm, more specifically between 0 μm and 1100 μm, measured from the cutting edge (221a-e) of the at least one cutting member (200a-e) in the shaving direction (x).
14. The razor head (10) according to embodiment 12 or embodiment 13, when dependent on embodiments 8 and 9, wherein, starting from the default position (130), the cutting member support (300) is configured to displace the at least one cutting member (200a-e) of the plurality of cutting members (200) in the vertical direction (z) towards the back side (160) of the frame (100) by a vertical distance (z1) between 0 μm and 1500 μm, more specifically between 0 μm and 1100 μm, measured from the cutting edge (221a-e) of the at least one cutting member (200a-e) in the vertical direction (z).
15. The razor head (10) according to any one of embodiments 12 to 14, when dependent on embodiment 7, wherein, starting from the default position (130), the cutting member support (300) is configured to displace the at least one cutting member (200a-e) of the plurality of cutting members (200) by a rotation about an axis defined by the perpendicular direction (y), wherein the rotation is defined by a rotation angle (r), more specifically wherein the rotation angle (r) is between −20°<r<+20°, in particular wherein the rotation angle (r) is between −5°<r<+5°.
16. The razor head (10) according to any one of embodiments 10 to 15, when dependent on embodiment 7, wherein, in the default position (130), the plurality of cutting members (200) defines a plurality of substantially parallel first inter-blade spans (s1), wherein the inter-blade spans (s1) are measured parallel to the shaving direction (x) between the subsequent, respective cutting edges (221a-e) of the plurality of cutting members (200).
17. The razor head (10) according to any one of embodiments 10 to 16, when dependent on embodiment 8, wherein, in the default position (130), a second span (s2) measured parallel to the shaving direction (x) is defined between leading longitudinal member (110) and a cutting edge (221a-e) of a cutting member (200a-e), being disposed adjacent the leading longitudinal member (110), and wherein, in the default position (130), a third span (s3) measured parallel to the shaving direction (x) is defined between trailing longitudinal member (120) and a cutting edge (221a-e) of a cutting member (200a-e), being disposed adjacent the trailing longitudinal member (120).
18. The razor head (10) according to embodiments 16 and 17, when dependent on embodiment 12, wherein, in the predetermined deviating position (140), at least one of the first inter-blade spans (s1), second span (s2) and third span (s3) is larger or smaller than in the default position (130), depending on the axial distance (x1), vertical distance (z1) and/or rotation angle (r).
19. The razor head (10) according to any one of the preceding embodiments, wherein the external stimulus is a temperature variation and/or a moisture variation.
20. The razor head (10) according to embodiment 19, wherein in a first temperature range of about 18° C. to 25° C., the plurality of cutting members (200) is in the default position (130).
21. The razor head (10) according to embodiment 19 or embodiment 20, wherein in a second temperature range of about 25° C. to 50° C., the at least one cutting member (200a-e) of the plurality of cutting members (200) is displaced from the default position (130) to the at least one predetermined deviating position (140).
22. The razor head (10) according to any one of embodiments 19 to 21, when dependent on embodiment 2, wherein the at least one responsive shape-shift component (310) of the cutting member support (300) is configured to perform a first shape-shift from the default position (130) to a first predetermined deviating position (141) at a first transition temperature, more specifically wherein the first transition temperature is between 24° C. and 28° C.
23. The razor head (10) according to embodiment 22, wherein the at least one responsive shape-shift component (310) of the cutting member support (300) is configured to perform a second shape-shift from the first predetermined deviating position (141) to a second predetermined deviating position (142) at a second transition temperature, more specifically wherein the second transition temperature is higher than the first transition temperature, in particular wherein the second transition temperature is between 37° C. and 42° C.
24. The razor head (10) according to any one of embodiments 8 to 23, wherein the frame (100) comprises a first side portion (170) and a second side portion (171), each extending in the shaving direction (x) between leading longitudinal member (110) and trailing longitudinal member (120) on opposite sides of the leading longitudinal member (100) and the trailing longitudinal member (120), with respect to the perpendicular direction (y).
25. The razor head (10) according to embodiment 24, wherein the frame (100) comprises a first cutting member retainer (180) and a second cutting member retainer (181) configured to be pushed onto the first side portion (170) and the second side portion (171) in the perpendicular direction (y), wherein the first cutting member retainer (180) and the second cutting member retainer (181) are configured to retain the plurality of cutting members (200) when inserted in the frame (100).
26. The razor head (10) according to any one of the preceding embodiments, wherein the cutting member support (300) comprises a plurality of resilient fingers (320), wherein a pair of fingers (320a1, 320a2) of the plurality of fingers (320) is coupled to a cutting member (200a-e) of the plurality of cutting members (200), respectively.
27. The razor head (10) according to embodiment 26, when dependent on embodiment 8, wherein each pair of fingers (320a1, 320a2) is in corresponding alignment in the perpendicular direction (y).
28. The razor head (10) according to embodiment 26 or embodiment 27, when dependent on embodiment 2, wherein at least one pair of fingers (320a1, 320a2) of the plurality of fingers (320) comprises the responsive shape-shift component (310) of the cutting member support (300) configured to perform the shape-shift based on the external stimulus.
29. The razor head (10) according to any one of embodiments 26 to 28, wherein the cutting member support (300), more specifically each pair of fingers (320a1, 320a2) is coupled to the plurality of cutting members (200) by positive locking, non-positive locking, or adhesive bonding.
30. The razor head (10) according to any one of embodiments 26 to 29, when dependent on embodiment 24, wherein each pair of fingers (320a1, 320a2) extends substantially in the perpendicular direction (y) from the first side portion (170) and the second side portion (171) towards a center (c) of the frame (100), respectively.
31. The razor head (10) according to any one of the preceding embodiments, wherein the cutting member support (300) comprises a base portion (330) that is attached to the frame (100) proximate a center (c) of the frame (100).
32. The razor head (10) according to embodiment 31, when dependent on embodiments 8 and 26, wherein the plurality of fingers (320) extends from the base portion (330) in the perpendicular direction (y) towards the first side portion (170) and the second side portion (171), respectively.
33. The razor head (10) according to any one of embodiments 26 to 32, when dependent on embodiments 8 and 9, wherein, in the default position (130), each finger (320a-e) of the plurality of fingers (320) is configured to exert a bias force against the plurality of cutting members (200) in the vertical direction (z) towards the shaving plane (SP).
34. The razor head (10) according to any one of embodiments 25 to 33, wherein, in the default position (130), the plurality of cutting members (200) bear against corresponding stop portions, more specifically wherein the stop portions are the first cutting member retainer (180) and the second cutting member retainer (181).
35. The razor head (10) according to any one of embodiments 24 to 34, wherein the frame (100), more specifically the first side portion (170) and the second side portion (171), comprises a plurality of cutting member guides (190) defining a plurality of cutting member support slots (191a-e), each cutting member support slot (191a-e) configured to accommodate a cutting member (200a-e) of the plurality of cutting members (200), wherein each cutting member (200a-e) is disposed in a respective cutting member support slot (191a-e).
36. The razor head (10) according to any one of embodiments 25 to 35, when dependent on embodiment 8, further comprising at least two spring elements (400a, 400b) arranged adjacent the first side portion (170) and the second side portion (171), respectively, between the plurality of cutting members (200) and the frame (100), more specifically between the plurality of cutting members (200) and first cutting member retainer (180) and the second cutting member retainer (181), respectively, wherein the at least two spring elements (400a, 400b) are configured to exert a bias force in the vertical direction (z) towards a center (c) of the frame (100).
37. The razor head (10) according to embodiment 36, when dependent on embodiment 33, wherein, in the default position (130), the bias force of the at least two spring elements (400a, 400b) is lower than the bias force of the plurality of resilient fingers (320).
38. The razor head (10) according to embodiment 36 or embodiment 37, when dependent on embodiments 2 and 33, wherein, when the at least one responsive shape-shift component (310) performs a shape-shift from the default position (130) to the at least one predetermined deviating position (140) based on the external stimulus, the at least two spring elements (400a, 400b) push at least one cutting member (200a-e) of the plurality of cutting members (200) towards the plurality of fingers in the vertical direction (z).
39. The razor head (10) according to any one of embodiments 9 to 38, wherein on a back side (160) of the frame (100) opposite the skin-contacting side (150), the frame (100) comprises a coupling section (500) configured to couple the razor head (10) to a razor handle (20), more specifically wherein the coupling section (500) is configured to releasably couple the razor head (10) to the razor handle (20) via a pivotable or a non-pivotable coupling.
40. A kit of parts, comprising:
   a razor head holder comprising a plurality of razor heads (10) according to any one of the preceding embodiments, and
   a razor handle (20).
41. A razor (1), comprising:
   a razor head (10) according to any one of embodiments 1 to 39, and
   a razor handle (20), wherein the razor head (10) is coupled to the razor handle (20).
42. The razor (1) according to embodiment 41, wherein the razor head (10) is coupled to the razor handle (20) via a coupling section (500), more specifically wherein the coupling section (500) comprises a connecting adapter.
43. The razor (1) according to embodiment 42, wherein the razor head (10), more specifically the connecting adapter, is integrally formed with the razor handle, or, wherein the razor head (10), more specifically the connecting adapter, is releasably coupled to the razor handle (20).
44. The razor (1) according to any one of embodiments 41 to 43, wherein the razor handle (20) comprises a retention and/or release mechanism configured to couple the razor head (10) to the razor handle (20) and/or to decouple the razor head (10) from the razor handle (20).
45. A method (600) of operating a razor (1), comprising the steps of:
   a) providing (610) a razor (1) comprising a razor head (10) according to any one of embodiments 1 to 39,
   b) performing a shaving operation (620) with the razor (1), wherein the razor head (10) is configured to cut hair of a user (U),
   c) exposing (630) the razor head (10) to an external stimulus, wherein the cutting member support (300) is configured to displace at least one cutting member (200a-e) of the plurality of cutting members (200) from a default position (130) to at least one predetermined deviating position (140) based on the external stimulus,
   d) terminating (640) the exposure of the razor head (10) to an external stimulus, wherein the cutting member support (300) is configured to replace the at least one cutting member (200a-e) of the plurality of cutting members (200) from the at least one predetermined deviating position (140) to the default position (130).
46. The method (600) according to embodiment 45, wherein the external stimulus is a temperature variation and/or a moisture variation.
47. The method (600) according to embodiment 46, wherein the shaving operation is performed at a first temperature range.
48. The method (600) according to embodiment 47, wherein exposing (630) the razor head (10) to an external stimulus comprises rinsing the razor head (10) with a liquid at a second temperature range, more specifically wherein the second temperature range is higher than the first temperature range.

### REFERENCE NUMERALS

x shaving direction
y perpendicular direction
z vertical direction
x1 axial distance
x2 axial distance
x3 axial distance
z1 vertical distance
z2 vertical distance
w1 narrowest cross-section
w2 narrowest cross-section
r rotation angle
c geometric center of frame
s1 inter-blade span
s2 span
s3 span
SP shaving plane
L1 length of connection portion
L2 total length of blade
L3 total length of cutting member
L4 length of lower portion
LS length of top portion
H height of cutting member
E exposure
T1 thickness of blade
T2 thickness of blade support
A approach angle
RI inner radius of bent portion
RO outer radius of bent portion
1 razor
10 razor head
20 razor handle
100 frame
101 guard member
110 leading longitudinal member
120 trailing longitudinal member
121 skin care element
130 default position
140 predetermined deviating position
150 skin-contacting side
160 back side
170 first side portion
171 second side portion
180 first cutting member retainer
181 second cutting member retainer
190 cutting member guide
191a-d cutting member support slot
200 plurality of cutting members
200a-e cutting members
210 blade support
211 lower portion
212 top portion
213 radius bent portion
214 lower side
220 blade
221a-e cutting edge
300 cutting member support
310 responsive shape-shift component
320 plurality of resilient fingers
330 base portion
320a1 first resilient finger
320a2 first resilient finger
320b1 second resilient finger
320b2 second resilient finger
400a,b spring elements
500 coupling section
600 method
700 trimming assembly
710 trimming cutting member
720 trimming cutting member support slot
730 retractable cover

1. A razor head, comprising:
a frame comprising a leading longitudinal member and a trailing longitudinal member,
a plurality of substantially parallel cutting members disposed between the leading longitudinal member and the trailing longitudinal member, and
a cutting member support arranged in the frame, wherein the cutting member support is coupled to the plurality of cutting members,
characterized in that the cutting member support is configured to displace at least one cutting member of the plurality of cutting members from a default position to at least one predetermined deviating position based on an external stimulus.

2. The razor head according to claim 1, wherein the cutting member support comprises at least one responsive shape-shift component, which is configured to perform a shape-shift from the default position to the at least one predetermined deviating position based on the external stimulus.

3. The razor head according to claim 2, wherein the at least one responsive shape-shift component comprises a responsive shape-shifting polymer.

4. The razor head according to claim 3, wherein the responsive shape-shifting polymer is combined with responsive liquid crystal elastomers (LCE) that are adapted to change their shape back and forth according to the external stimulus applied.

5. The razor head according to claim 1, wherein the razor head comprises a shaving direction, a perpendicular direction which is perpendicular to the shaving direction, and a vertical direction which is perpendicular to the shaving direction and the perpendicular direction, wherein the frame comprises a skin-contacting side defining a shaving plane (SP), and wherein the frame comprises a back side opposite the skin-contacting side.

6. The razor head according to claim 5, wherein, starting from the default position, the cutting member support is configured to displace the at least one cutting member of the plurality of cutting members in one or more of the shaving direction, the vertical direction, and/or by a rotation about an axis defined by the perpendicular direction, based on the external stimulus.

7. The razor head according to claim 5, wherein, starting from the default position, the cutting member support is configured to displace the at least one cutting member of the plurality of cutting members in the shaving direction towards the leading longitudinal member or towards the trailing longitudinal member by an axial distance, wherein the axial distance is between 0 μm and 1500 μm, measured from a cutting edge of the at least one cutting member in the shaving direction.

8. The razor head according to claim 7, wherein the axial distance is between 0 μm and 1100 μm measured from a cutting edge of the at least one cutting member in the shaving direction.

9. The razor head according to claim 5, wherein, starting from the default position, the cutting member support is configured to displace the at least one cutting member of the plurality of cutting members in the vertical direction towards the back side of the frame by a vertical distance between 0 μm and 1500 μm, measured from a cutting edge of the at least one cutting member in the vertical direction.

10. The razor according to claim 9, wherein starting from the default position, the cutting member support is configured to displace the at least one cutting member of the plurality of cutting members in the vertical direction towards the back side of the frame by a vertical distance between 0 μm and 1100 μm, measured from a cutting edge of the at least one cutting member in the vertical direction.

11. The razor head according to claim 5, wherein, starting from the default position, the cutting member support is configured to displace the at least one cutting member of the plurality of cutting members by a rotation about an axis defined by the perpendicular direction.

12. The razor head according to claim 11, wherein the rotation is defined by a rotation angle (r), wherein the rotation angle (r) is between −20°<r<+20°.

13. The razor head according to claim 11, wherein the rotation is defined by a rotation angle (r), wherein the rotation angle (r) is between −5°<r<+5°.

14. The razor head according to claim 1, wherein the external stimulus is one or more of a temperature variation and/or a moisture variation.

15. The razor head according to claim 13, wherein in a first temperature range of about 18° C. to 25° C., the plurality of cutting members is in the default position, and wherein in a second temperature range of about 25° C. to 50° C., the at least one cutting member of the plurality of cutting members is displaced from the default position to the at least one predetermined deviating position.

16. The razor head according to claim 1, wherein the cutting member support comprises a plurality of resilient fingers, wherein a pair of fingers of the plurality of fingers is coupled to a cutting member of the plurality of cutting members, respectively.

17. The razor according to claim 15, wherein at least one pair of fingers of the plurality of fingers comprises the responsive shape-shift component of the cutting member support configured to perform the shape-shift based on the external stimulus.

18. A kit of parts, comprising:
a razor head holder comprising a plurality of razor heads according to claim 1, and
a razor handle.

19. A razor, comprising:
a razor head according to claim 1, and
a razor handle, wherein the razor head is coupled to the razor handle.

20. A method of operating a razor, comprising the steps of:
a) providing a razor comprising a razor head according to claim 1,
b) performing a shaving operation with the razor, wherein the razor head is configured to cut hair of a user (U),
c) exposing the razor head to an external stimulus, wherein the cutting member support is configured to displace at least one cutting member of the plurality of cutting members from a default position to at least one predetermined deviating position based on the external stimulus,
d) terminating the exposure of the razor head to an external stimulus, wherein the cutting member support is configured to replace the at least one cutting member of the plurality of cutting members from the at least one predetermined deviating position to the default position.
